(19) United States
(12) Patent Application Publication
(10) Pub. No.: US 2019/0016237 A1
(43) Pub. Date: Jan. 17, 2019

(54) MOTOR VEHICLE

(71) Applicant: GM GLOBAL TECHNOLOGY OPERATIONS LLC, Detroit, MI (US)

(72) Inventor: Andrzej Pleskot, Seeheim-Jugenheim (DE)

(73) Assignee: GM GLOBAL TECHNOLOGY OPERATIONS LLC, Detroit, MI (US)

(21) Appl. No.: 16/033,673

(22) Filed: Jul. 12, 2018

(30) Foreign Application Priority Data
Jul. 12, 2017 (DE) 102017006580.2

(51) Int. Cl. B60N 2/16; B60N 2/02

(52) U.S. Cl. CPC B60N 2/1615; B60N 2/0232

(57) ABSTRACT

A height-adjustable seat includes a seat part having a frame and a back part. At pivot lever is pivotally mounted about a pivot axis for height adjustment of the seat by a pivoting movement of the pivot lever. A movable connecting member is connected to the pivot lever by a first pivot lever joint so that a movement of the connecting member causes a pivoting movement of the pivot lever about the pivot axis. An actuating member moves the connecting member with a gear wheel. A movable transmission member having teeth transmits a force from the gear wheel to the connecting member. The gear wheel meshes with the teeth of the transmission members, which is in mechanical operative connection to the connecting member so that a movement of the transmission member causes movement of the connecting member. The connecting member is mounted to a base part and subjected to a compression load.

### CROSS-REFERENCE TO RELATED APPLICATION

This application claims priority to German Patent Application No. 102017006580.2, filed Jul. 12, 2017, which is incorporated herein by reference in its entirety.

### TECHNICAL FIELD

The present disclosure relates to a seat, a method for manufacturing a seat and a motor vehicle.

### BACKGROUND

Motor vehicles have an interior with seats arranged therein. Front seats typically have a seat part and a back part pivotally mounted about a pivot axis. Rear seats are arranged behind the front seats within the interior of the motor vehicle. The rear seats are thereby generally combined to form a rear seat bench having three seating locations. The front seats typically include a rail as a support structure that is fixedly fastened with a fastening device to the vehicle body.

Some seats may be adjustable with a height adjustment device in a vertical direction or a Z-direction. An actuating member as a so-called mechanical pump has an actuating lever for moving a gear wheel for rotating as an actuating member on a drive shaft of the pump. The teeth of the gear wheel mesh with a component with teeth, so that thereby, a connecting element can be moved on the basis of a rotational or turning movement of the gear wheel. The movement of the connecting element causes a pivoting movement of a pivot lever on the basis of a corresponding kinematic coupling of the connecting element with the pivot lever. The height adjustment device has a total of four pivot levers, of which only one pivot lever is moved by the actuating member via the connecting element. However, the four pivot levers are coupled with one another with a mechanism, so that all four pivot levers move at the same time. The four pivot levers are each mounted on a corner region of a frame of the seat, so that thereby, a pivoting movement of the pivot lever causes a height adjustment of the seat. In addition, a slight movement in the longitudinal direction or in an X-direction of the motor vehicle of the seat is also caused when adjusting the height due to the kinematic design of the pivot lever. The actuating member and thus also the actuating lever have a small distance to a rear end of the seat.

As a result, the actuating lever is arranged disadvantageously in the region of a retractor for a seat belt of the seat. As a result, problems arise in the arrangement of the seat belt and the actuating lever. When assembling the seat, the frame is first manufactured and assembled with the height adjustment device. Only then is the assembly of the other components of the seat performed, for example, the padding and the seat cover. On the one hand, the assembly of the frame with the height adjustment device and, on the other hand, the assembly of the other components of the seat, can be performed in separate workshops. Due to the many individual parts of the height adjustment device, a complex tolerance compensation is necessary during assembly of the height adjustment device. For example, the teeth of the gear wheel of the actuating member must mesh with the teeth of the component and, for this, a corresponding complex adjustment or tolerance compensation of the corresponding individual parts is necessary. A certain position of the teeth of the gear wheel in the component corresponds to a certain height of the seat, so this is correspondingly difficult to calibrate. In addition, when there is damage in the seat in a motor vehicle, for example, the need to replace the actuating member in a workshop, it is necessary to replace the entire seat, because the complex calibration or tolerance compensation is not possible in a workshop and this is only possible during the manufacture of the motor vehicle in a corresponding manufacturing plant. The individual parts of the height adjustment device, since they are, for example, also manufactured in different workshops, have high manufacturing inaccuracies in the final assembly, so that in the final assembly of the seat, these manufacturing inaccuracies are compensated by a correspondingly complex tolerance compensation.

CN 203957921 U shows a seat having a height adjustment device. A sector with teeth is fastened to a crossbar and teeth of a gear wheel mesh with these teeth of the sector. The gear wheel is set into rotational movement by a pump.

US 2010/0109406 A1 shows a seat actuating device for the height adjustment of the seat and pivot position of a back part of the seat. The height adjustment of the seat and the change of the pivot position of the back part can be effected with an actuating arm.

DE 10 2016 010 648 A1 shows a generic height-adjustable seat. A connecting member of a height adjustment device of the seat is subject to tensile stress.

### SUMMARY

The present disclosure provides a seat, a method for manufacturing a seat and a motor vehicle, in which the seat has low manufacturing costs, is easy to assemble and an actuating lever for the height adjustment of the seat has a long distance in the longitudinal direction to a rear crossbar and the connecting member is built structurally simple due to the force stress.

In an embodiment, a seat includes a seat part having a frame and a back part. At least one pivot lever is pivotally mounted about a pivot axis for height adjustment of the seat by a pivoting movement of the pivot lever. A movable connecting member is connected articulatedly to the pivot lever, in particular only one pivot lever, by a first pivot lever joint, so that a movement of the connecting member causes a pivoting movement of the pivot lever about the pivot axis. An actuating member indirectly, moves the connecting member with a gear wheel. A movable transmission member has teeth for transmitting a force from the gear wheel of the actuating member to the connecting member. The teeth of the gear wheel mesh with the teeth of the transmission member and the transmission member is in mechanical operative connection with the connecting member so that a movement of the transmission member causes a movement of the connecting member. The connecting member is mounted on a base part. The connecting member is subjected to a compression load, which advantageously allows a more effective and simple structural dimensioning of the connecting member. In addition, the connecting member and the base part may form a first assembly unit that can be preassembled. This first assembly unit that can be preassembled and readily affixed after the preassembly or assembly altogether as a first assembly unit on the frame, so that in an advantageous manner, the assembly is much easier.

In a further embodiment, the base part is formed by a first base plate and preferably a second base plate.

Suitably, the first and second base plates are aligned substantially parallel to each other, wherein substantially parallel means that the first and second base plates are aligned with a deviation of less than 20°, 10°, 5°, 3° or 2° parallel to each other. The first and second base plates span a fictitious plane and these spanned two fictitious planes are aligned substantially parallel to each other. The transmission member joint is mounted on the two base plates, so that due to the configuration of two base plates aligned parallel to each other, lower shear forces and lateral displacements occur on the base plates than with a mounting of the transmission member joint on only one base plate.

In a complementary variation, the pivot lever, the connecting member and the transmission member together with joints form a mechanism for pivoting the pivot lever about the pivot axis of the third pivot lever joint by means of a movement, in particular pivoting movement of the transmission member.

In a further variation, the pivot lever and the connecting member together with the first pivot lever joint between the pivot lever and the connecting member, a second pivot lever joint between the frame and/or a crossbar and the pivot lever, a third pivot lever joint between the pivot lever and a sliding carriage and a connecting member joint between the connecting member and the transmission member, form a mechanism for pivoting the pivot lever about a pivot axis at the third pivot lever joint by movement, in particular pivoting movement, of the transmission member. The mechanism transmits a force from the transmission member to the pivot lever so that movement of the transmission member causes a pivoting movement of the pivot lever. The movement of the transmission member and the pivoting movement of the pivot lever are thereby aligned with each other in a predetermined transmission ratio, so that each one position of the transmission member unchangeably corresponds to each one position of the pivot lever. The mechanism thus enables a desired mechanical translation of the movement between the transmission member and the pivot lever. The transmission member and the pivot lever are thus kinematically coupled with each other.

In particular, the base part is a separate component in addition to the frame.

In an additional embodiment, the base part with at least one fixing element, in particular at least one screw, is fixed to the frame.

In a supplementary variation, the actuating member with at least one fixing element, in particular at least one screw, is fixed to the frame.

In an additional embodiment, the base part and the actuating member are exclusively fixed to the frame with at least one identical fixing element. The base part and the actuating member can be particularly easily fixed to the frame with at least one identical fixing element. The fixing of the base part and the actuating member is thus particularly simple, safe and reliable during assembly.

In a further embodiment, the actuating member is partially fixed in the region of an outer side of the frame and/or resting on the outer side of the frame and the gear wheel of the actuating member and the base part together with the transmission member and the connecting member are fixed in the region of an inner side of the frame and/or between two lateral frame components. Preferably, the frame has an opening for the passage of the gear wheel and the diameter of the opening is larger than the diameter of the gear wheel. During assembly of the actuating member and the base part, the gear wheel, through this, can be particularly easily passed through the opening on the frame and then the actuating member and the base part with the at least one, preferably identical, fixing element can be particularly securely and reliably fixed to the frame. Preferably, the fixation of a component in the region of the outer side or inner side of the frame means that the component has a distance of less than 20 cm, 10 cm, 7 cm, 5 cm, 3 cm, 2 cm or 1 cm to the inner side or outer side of the frame.

In an additional embodiment, the transmission member is pivotally mounted on the base part about a transmission member pivot axis with a transmission member joint.

In a further embodiment, the transmission member and/or the gear wheel is arranged between the first and second base plate.

In an additional embodiment, the connecting member is pivotally mounted on the transmission member about a, preferably first, connecting member pivot axis with a connecting member joint.

In a further variation, the connecting member, in particular a connecting lever is subjected to a compression load in all positions of the connecting member.

In an additional embodiment, the first pivot lever joint is arranged between the pivot lever and the connecting member, in particular in all positions of the first pivot lever joint, vertically lower than a third pivot lever joint between the pivot lever and the sliding carriage. This enables a particularly advantageous kinematic coupling between the transmission member and the pivot lever with an optimized transmission ratio.

Suitably, the seat includes four pivot levers, which are kinematically connected to one another with a mechanism, so that a force applied to only one pivot lever with the connecting member for pivoting the pivot lever causes a simultaneous pivoting movement of all four pivot levers.

In an additional embodiment, the teeth of the transmission member have a constant radial distance to the transmission member pivot axis. Even with a pivoting or rotational movement of the transmission member about the transmission member pivot axis, the teeth of the transmission member mesh securely and reliably with the teeth of the gear wheel on the actuating member.

A method according to the present disclosure for manufacturing a seat such as described herein having a base part, a transmission member with teeth, a connecting member and the transmission member and the connecting member being pivotally mounted on the base part and the base part. Forming first assembly including the transmission member and preferably the connecting member. An actuating member is provided with a gear wheel to form a second assembly unit. A frame is provided for a seat part of the seat. A at least one pivot lever is provided for height adjustment of the seat by pivoting movement of the at least one pivot lever. The base part is provided in two parts as a first base plate and a second base plate.

In a further variation, the first and second base plates are manufactured by stamping, in particular fine blanking, and/or forming. The first and second base plates can, based on the manufacturing, be manufactured by stamping with a high manufacturing accuracy of about 0.3 mm. Thus, among other things, advantageously, no calibration or tolerance compensation is necessary during assembly of the height adjustment device. In addition, only slight gravitational forces and lateral displacements occur because the transmission member is mounted with two base plates.

In an additional embodiment, the transmission member and/or the gear wheel is arranged between the first and second base plate.

Suitably, the first and second base plates are fastened substantially parallel to one another on a support structure, in particular the frame, indirectly or directly.

In a further embodiment, first the teeth of the gear wheel of the actuating member are brought into mechanical operative connection with the teeth of the transmission member as a meshing of the teeth and then the connecting member is connected articulatedly to the pivot lever by the first pivot lever joint.

In an additional embodiment, the first assembly unit and/or the second assembly unit are fixed to the frame with at least one fixing element prior to the manufacture of the mechanical operative connection of the teeth of the gear wheel and the teeth of the transmission member.

Suitably, the first and second assembly units are simultaneously fixed to the frame with at least one, preferably identical, fixing element.

In particular, the components of the first and second assembly units are first assembled to the first and second assembly unit, and then the already assembled first and second assembly unit is fixed to the frame with the at least one fixing element.

A motor vehicle according to the present disclosure, including an body, at least one drive motor, in particular an internal combustion engine and/or electric motor, at least one seat, wherein the seat is configured as a seat described in this patent application.

In an additional embodiment, the height adjustment device includes a rear crossbar and a front crossbar, which are kinematically coupled to each other with a mechanism so that thereby, a rotational movement, each with a rotation axis, which each corresponds to the longitudinal axis of the individual crossbars, is simultaneously executable by two crossbars, so that a pivoting movement is also executable for height adjustment of the seat by the pivot lever on the front and rear crossbar.

Preferably, the two crossbars are kinematically coupled to each other by the frame and the pivot lever to form the mechanism and to this the front and rear crossbar is articulated with second pivot lever joints on the frame.

In a further embodiment, the at least one pivot lever is mounted about a pivot axis on a sliding carriage and/or on the auto body of the motor vehicle with a third pivot lever joint and with a second pivot lever joint. The pivot lever is mounted on the frame. In particular each crossbar is mounted on the frame with the second pivot lever joint and due to the fixed configuration of the pivot lever on the crossbar. The pivot lever is thus indirectly articulated to the frame by means of the second pivot lever joint.

In an additional embodiment, the actuating member is a mechanical actuating member with an actuating lever or an electric actuating member with an electric motor for moving the gear wheel.

In an additional embodiment, the at least one fixing element is a screw or a rivet.

In an additional embodiment, the frame is arranged between the actuating member and the base part. In particular only the frame is arranged between a holding plate of the actuating member and the base part, in particular the first base plate. Preferably, the holding plate of the actuating member rests on an outer side of the frame and the first base plate rests directly on an inner side of the frame.

In an additional embodiment, the pivot lever is articulated to the connecting member with a first pivot lever joint.

In a further embodiment, the crossbar and/or the pivot lever is articulated to the frame with a second pivot lever joint.

Preferably, the seat includes four second pivot lever joints, so that in each case a crossbar is mounted on the frame with two second pivot lever joints.

In a further embodiment, at least one pivot axis, preferably all pivot axes, are aligned in the Y-direction of the motor vehicle, for example, the at least one pivot axis is the pivot axis of the pivot lever and/or first and/or second connecting member pivot axis and/or a transmission member pivot axis.

In an additional variation, the pivot lever is mounted with a third pivot lever joint on a sliding carriage and/or on an auto body indirectly or directly.

In a further variation, the seat includes four pivot levers, in particular the four pivot levers are configured on axial end regions of a rear and front crossbar.

Preferably, all geometries for the form-fitting transmission of force are considered as a gear wheel on the actuating member and the teeth on the transmission member, in particular an element with form-fitting geometries may also be configured on the actuating member as a gear wheel which performs a translational movement.

In a further embodiment, the gear wheel in the X-direction has a distance of at least 8 cm, 10 cm, 12 cm, 15 cm, 20 cm or 25 cm to a longitudinal axis of the rear crossbar. An actuating lever for the actuating member can thus be configured at a sufficient distance to a retractor of a seat belt of the seat. The large distance is easily feasible due to the structural configuration of the height adjustment device with the connecting member, the transmission member and the base part.

In an additional embodiment, the extension of the base part in the X-direction is less than 50%, 40%, 30%, 20%, 10% or 5% of the extent of the frame in the X-direction.

In an additional embodiment, the seat is manufactured with a method described herein.

In a further variation, the method described herein is executed to the effect that the seat is configured according to the seat described in this patent application.

In an additional embodiment, the frame and/or the base part and/or the connecting member and/or the transmission member and/or the at least one crossbar and/or the at least one pivot lever and/or the at least one crossbar and/or the holding plate of the actuating member is at least partially, in particular completely, made of metal, in particular steel and/or aluminum.

In an additional embodiment, a back part of the seat is pivotable about a, preferably horizontal, pivot axis.

Preferably, the back part and the seat part are connected to each other with at least one connecting part.

### BRIEF DESCRIPTION OF THE DRAWINGS

The present disclosure will hereinafter be described in conjunction with the following drawing figures, wherein like numerals denote like elements.

FIG. 1 is a side view of a motor vehicle,

FIG. 2 is a longitudinal section of a front seat of the motor vehicle,

FIG. 3 is an exploded view of a support structure of the front seat,

FIG. 4 is a partial side view of the support structure with frame and a height adjustment device for the front seat,

FIG. 5 is an exploded view of the height adjustment device of FIG. 4,

FIG. 6 is an exploded view of a first assembly unit of the height adjustment device of FIG. 4

FIG. 7 is a perspective view of the height adjustment device according to FIG. 4.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

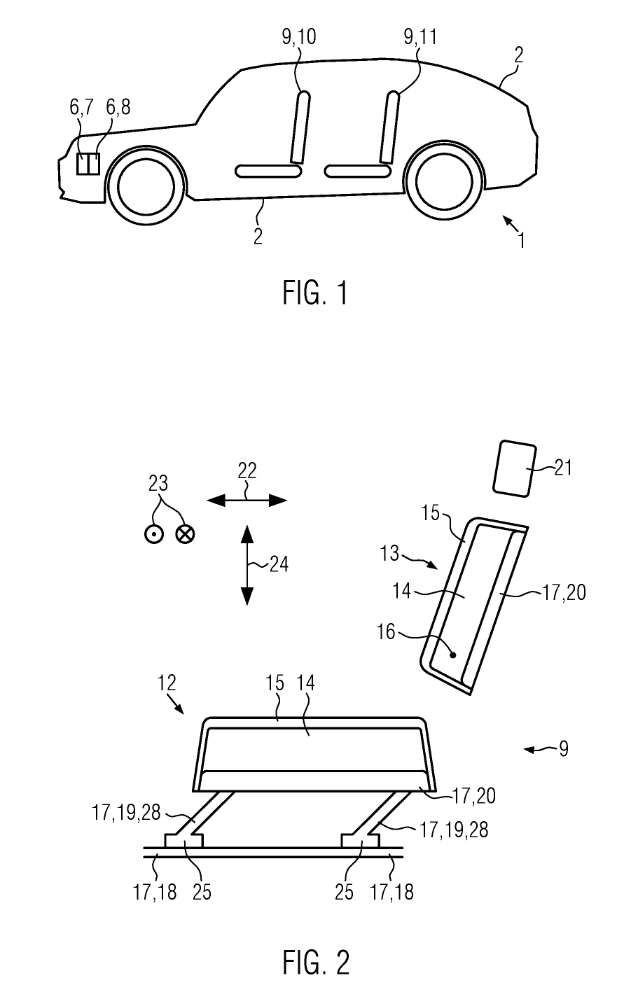

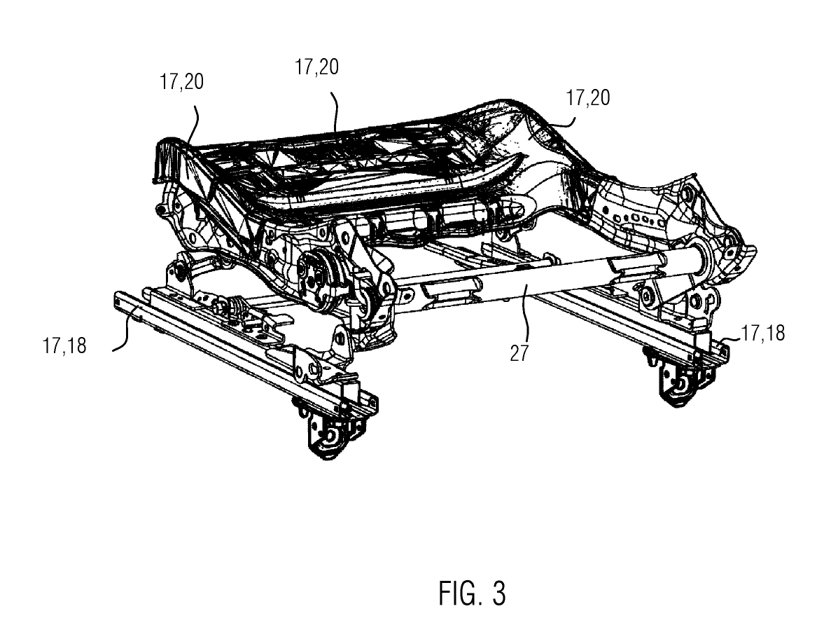

A motor vehicle shown in FIG. 1 as a hybrid or electric motor vehicle 1 has an auto body 2 made of metal, in particular steel. The motor vehicle 1 is moved by a drive motor 6, for example, an electric motor 7 and/or an internal combustion engine 8. An electric motor vehicle 1 has only the electric motor 7 as the drive motor 6, and a hybrid motor vehicle 1 has both the electric motor 7 and the internal combustion engine 8. The auto body 2 made of steel defines an interior and inside the interior are arranged two front seats 10 as seats 9 and three rear seats 11 as seats 9. The three rear seats 11 are combined to form a seat bench.

A longitudinal section through the front seat 10 is shown in FIG. 2. The front seat 10 includes a seat part 12 and a back part 13. The seat part 12 and the back part 13 each have a frame 20 as a support structure 17 on which a padding 14 and a seat cover 15 are fastened. On the back part 10, a headrest 21 is further fastened. The back part 13 is pivotable about a pivot axis 16. The seat part 12 is fastened with support feet 19 on two rails 18 as a pivot lever 28. By the support feet 19 and a respective sliding carriage 25 at the lower end of the support feet 19, which are mounted movably on the rails 18, the entire front seat 7 can be moved horizontally in the longitudinal direction or X-direction 22 of the motor vehicle 1. The frame 20 of the back part 13 is connected by connecting parts to the frame 20 of the seat part 12, so that thereby, in the horizontal and/or vertical movement of the front seat 7, both the seat part 12 and the back part 13 execute the horizontal and/or vertical movement together. The support structure 17 includes the frame 20, the support feet 19 and the rails 18. The seat 9 is not movable in a Y-direction 23 as a transverse direction of the motor vehicle 1. The seat 9 is adjustable with a height adjustment device 3 in the Z-direction 24 or vertical direction 24, so that the entire seat 9 may have a different vertical distance to the auto body 2 at the bottom of the motor vehicle 1.

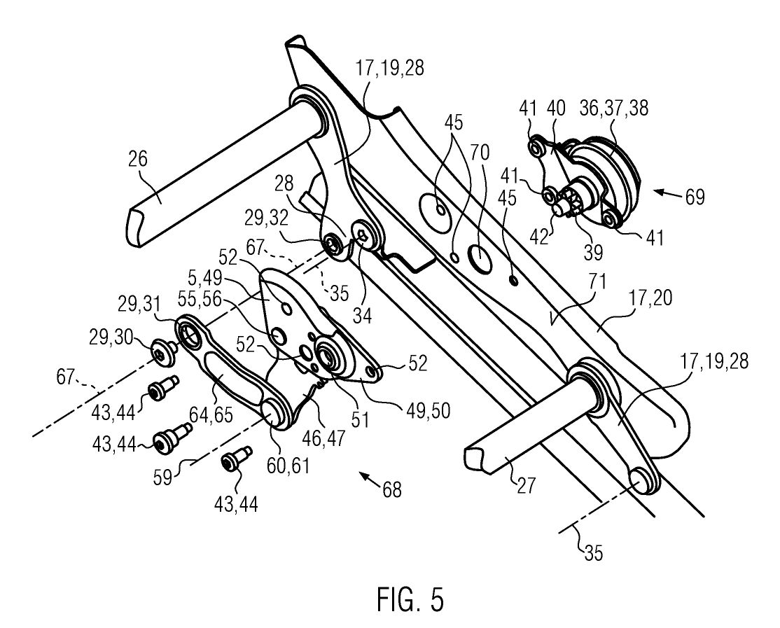

Four pivot levers 28 are arranged on the inner side in the region of inner sides 71 of the frame 20 in the longitudinal direction 22 of the motor vehicle 1 and in the X-direction 22 of the motor vehicle 1. The pivot levers 28 are each fastened torque-proof to the end regions of a rear crossbar 26 and a front crossbar 27. The two crossbars 26, 27 are kinematically coupled to each other by means of a mechanism 4, namely the frame 20 and the pivot lever 28. A pivoting or rotational movement of the rear crossbar 26 thus requires the same simultaneous pivoting movement of the front crossbar 27 due to this kinematic coupling by the mechanism 4. The two crossbars 26, 27 are mounted at their axial end regions in each case with a second pivot lever joint 33 on the frame 20, so that the seat 1 has a total of four second pivot lever joints 33. A lower end region of the pivot lever 28 is articulated to a respective sliding carriage 25, each with a third pivot lever joint 34. The four pivot levers 28 are thus articulated with four third pivot lever joints 34 on four sliding carriages 25 so that thereby the pivot lever 28 can execute a pivoting movement about a pivot axis 35. Thus, the two front pivot levers 28 execute a pivoting movement about a forward pivot axis 35 and the two rear pivot levers 28 execute a pivoting movement about a rear pivot axis 35 (FIG. 5). A pivoting movement of the pivot lever 28 about the pivot axes 35 thus causes a height adjustment of the seat 9 in the Z-direction 24. Due to the kinematics of the pivot lever 28, the seat 9 additionally executes a movement in a smaller extent in the X-direction 22 of the motor vehicle 1 during movement of the seat 9 in the Z-direction 24. A movement of the seat 9 upwards leads to a slight forward movement of the seat 9 in the X-direction 22 and a movement of the seat 9 downwards leads to a slight movement of the seat 9 in the X-direction 22 to the rear.

One of the pivots levers 28 operates as an output or drive link for pivoting movement at pivot lever joint 34 about the pivot axis 35 in the height adjustment device 3. The height adjustment device 3 additionally includes an actuating member 36 as a mechanical actuating member 37. The mechanical actuating member 37 may additionally have an actuating lever. The mechanical actuating member 37 is also referred to as a so-called mechanical pump or simply pump. The actuating lever can be actuated by a person on the seat 9, and this causes a rotational movement of a drive shaft 42 of the actuating member 37. A gear wheel 39 is fastened to the drive shaft 42. The actuating member 36 further has a holding plate 40 having three holes 41 with an internal thread or nuts. Notwithstanding this, the actuating member 36 may also be an actuating member 38 with an electric motor. In an actuating member 38 with an electric motor, the gear wheel 39 is not set into rotational motion with muscle power by the actuating lever, but rather by electrical energy driving the electric motor of the actuating member 38, that is, both the gear wheel 39 and the drive shaft 42 together execute a turning or rotational movement. The actuating member 36 additionally forms a second assembly unit 69.

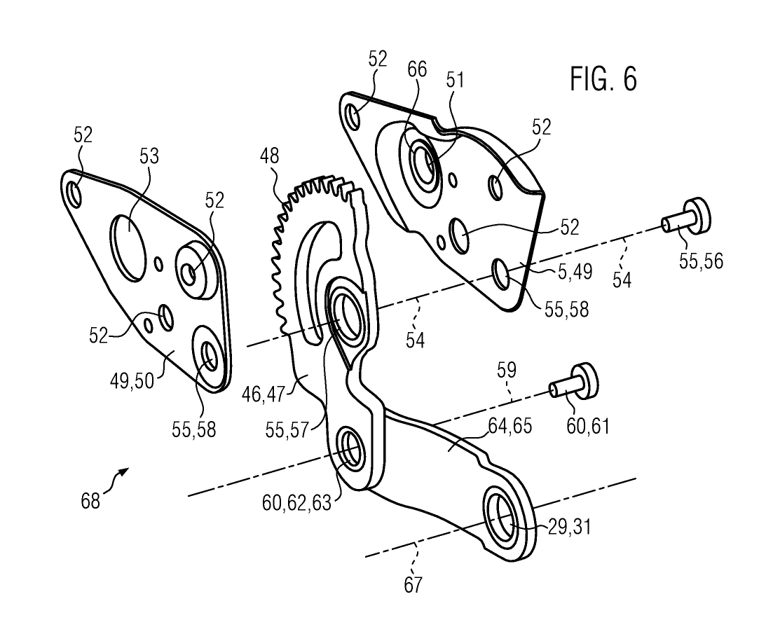

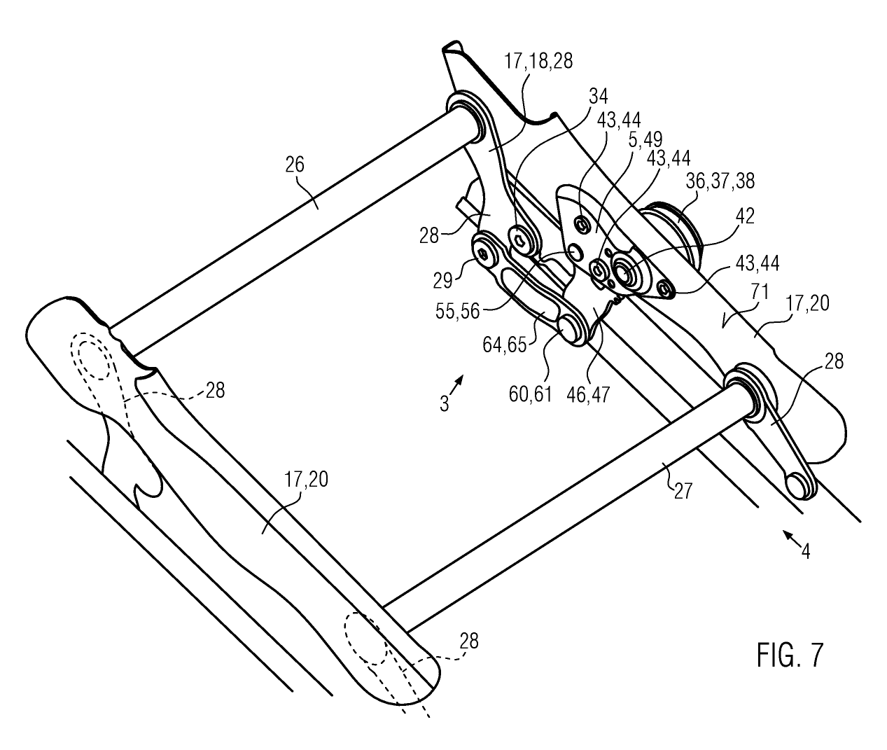

The height adjustment device 3 additionally includes a first assembly unit 68. The first assembly unit 68 includes a base part 49 as a first base plate 50 and a second base plate 5, a transmission member 46 as a sector 47, and a connecting member 64 as a connecting lever 65. The second base plate 5 has a bearing bore 51 for mounting the drive shaft 42 of the actuating member 36 in which a bearing bush 66 is fastened to an opening of the second base plate 5 and the bearing bush 66 limits the bearing bore 51. The first base plate 50 has an opening 53 for the gear wheel 39 and three holes 52. Three holes 52 are also configured on the second base plate 5. A bearing bore 58 is configured respectively on the first base plate 50 and the second base plate 5, for the articulation of the transmission member 46 on the base part 49, that is, the first base plate 50 and the second base plate 5. For this purpose, the transmission member 46 is pivotally mounted with a transmission member joint 55 on the base part 49 about a transmission member pivot axis 54. The transmission member joint 55 is formed by a bearing pin 56, a bearing bore 57 on the transmission member 46 and the bearing bores 58 on the base part 49. For this purpose, the bearing pin 56 is arranged within the bearing bore 57 and the bearing bores 58 on the first and second base plates 5, 50 (FIG. 6). The bearing pin 56 is preferably configured as a two-sided rivet 56. The transmission member 46 has a plurality of teeth 48 and the teeth 48 have a substantially constant radial distance to the transmission member pivot axis 54.

The connecting member 64 is pivotally mounted on the transmission member 46 about a first connecting member pivot axis 59 with a connecting member joint 60. The connecting member joint 60 includes a bearing pin 61, a bearing bore 62 on the connecting member 64 and a bearing bore 63 on the transmission member 46. The bearing pin 61 is arranged within the bearing bore 62 and the bearing bore 63 for this purpose.

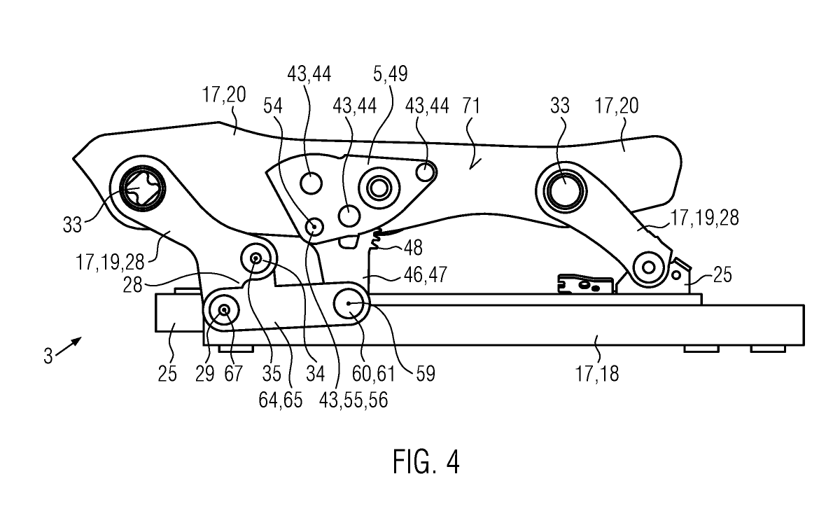

The connecting member 64 is articulated with a first pivot lever joint 29 about a second connecting member pivot axis 67 on only one pivot lever 28 on the rear crossbar 26. The first pivot lever joint 29 includes a bearing pin 30, a bearing bore 31 in the connecting member 64 and a bearing bore 32 in the pivot lever 28. The pivot lever 28 is formed as shown in FIGS. 4 and 5 of two partial pivot levers 28 which are fixedly configured on the rear crossbar 26. The bearing bore 32 is configured on the lower pivot part lever 28 in FIGS. 4 and 5. The bearing pin 30 is arranged within the bearing bores 31, 32.

In the manufacture of the seat 9, first, the first assembly unit 68 and the second assembly unit 69 are manufactured or assembled or made available, i.e., assembled together from appropriate individual parts. To fix the second assembly unit 69 as the actuating member 36 and the first assembly unit 68 with the base member 49, three fixing elements 43 are introduced as screws 44 in holes 52 on the base member 49 to the transmission member 46 and the connecting member 64 on the frame 20, that is, depending on the first and second base plate 5, 50, and also passed through three holes 45 on the frame 20 until the external threads of the screws 44 can be screwed into the internal threads on the holes 41 of the holding plate 40 of the actuating member 36. The actuating member 36, that is, the holding plate 40, thus rests directly on an outer side of the frame 20 and the base part 49, that is, the first base plate 50 rests directly on the inner side 71 of the frame 20. The gear wheel 39 is to be passed through fan opening 70 on the frame 20 for the assembly.

When assembling the first assembly unit 68, the assembly is facilitated by the fact that the first base plate 50 has the opening 53 for the passing through of the gear wheel 39. After assembling the first assembly unit 68, the gear wheel 39 and the transmission member 46 are arranged between the first and second base plates 5, 50. Only after the final fixing of the actuating member 36 or the second assembly unit 69 and the first assembly unit 68 to the frame 20 and the thereby already manufactured meshing of the teeth of the gear wheel 39 in the teeth 48 of the transmission member 46, is the connecting member 64 subsequently articulated with the first pivot lever joint 29 on the only one pivot lever 28 as the connecting lever 65. During this manufacture of the articulated connection by the first pivot lever joint 29 of the connecting member 64 on the pivot lever 28, the gear wheel 39 cannot be set into a rotational movement and thus the transmission member 46 cannot be pivoted about the transmission member pivot axis 54. A certain position of the teeth of the gear wheel 39 in the teeth 48 of the transmission member 46 is associated with a certain height position of the seat 9. To achieve this particular height position of the seat 9, the seat 9 is only to be brought by assemblers manually in a corresponding height position, so that the articulated connection can be manufactured by means of the first pivot lever joint 29 between the connecting member 64 and the pivot lever 28. After the manufacture and assembly of the height adjustment device 3, the connecting member 64 is constantly subjected to a compression load due to the kinematics between the pivot lever 28 and the connecting lever 64, in particular, because the first pivot lever joint 29 or the second connecting member pivot axis 67 is arranged in the Z-direction 24 or the vertical direction under the third pivot lever joint 34 or the pivot axis 35. The first pivot lever joint 29, the third pivot lever joint 34 and the second pivot lever joint 33 form a mechanism, so that due to the kinematics of the first pivot lever joint 29, of the third pivot lever joint 34 and of the second pivot lever joint 33 and of the pivot lever 28 and of the connecting member 64, a movement of the connecting member 64 causes a pivoting movement of the pivot lever 28 and thus a height adjustment of the seat 9; for the pivoting movement of the pivot lever 28 by means of the movement of the connecting member 64, thus not only the distance between the pivot axis 35 or the third pivot lever joint 34 and the second connecting member pivot axis 67 on the first pivot lever joint 29 is relevant.

On the whole, considerable advantages are associated with the seat 9 according to the present disclosure, the method according to the present disclosure for manufacturing the seat 9 and the motor vehicle 1 according to the present disclosure. The components of the first assembly unit 68 and the components of the second assembly unit 69 can be manufactured and/or assembled in only one manufacturing plant, so that thereby, only slight manufacturing inaccuracies occur within the first and second assembly units 68, 69. A tolerance compensation due to high manufacturing inaccuracy in the assembly of the seat 9 is not necessary. As a result, the costs for the manufacture of the height adjustment device 3 and thus of the seat 9 can be reduced in an advantageous manner. The already assembled first assembly unit 68 and second assembly unit 69 can also be fixed in a manufacturing plant on the frame 20, in which in a just-in-time production, the padding 14 and the seat cover 15 are assembled on the seat 9. For the manufacture of different seats 9, for example, with a seat 9 in which the actuating member 36 is not a mechanical actuating member 37, but rather an actuating member 38 with electric motor, only a second assembly unit 69 needs to be provided and this can be assembled in the manufacturing plant with just-in-time production. Since no complex tolerance compensation for the manufacture and assembly of the height adjustment device 3 is necessary, individual components of the height adjustment device, for example, the actuating member 36, can be replaced in a service workshop without a replacement of the entire seat 9 being necessary. As a result, in addition, the costs for a service case on the height adjustment device 3 in a motor vehicle 1 can be reduced.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A height-adjustable seat for a motor vehicle having a seat part and a back part, the seat part comprising:
a seat frame;
at least one pivot lever pivotally mounted about a pivot axis for height adjustment of the seat frame by a pivoting movement of the at least one pivot lever;
a movable connecting member mounted on a base plate and coupled to the pivot lever at a first pivot lever joint so that a movement of the connecting member causes a pivoting movement of the pivot lever about the pivot axis;
an actuating member having a gear wheel configured to move the connecting member;
a transmission member having teeth meshing with the gear wheel for transmitting a force from the gear wheel of the actuating member to the connecting member, wherein the transmission member is operably coupled with the connecting member so that a movement of the transmission member causes a movement of the connecting member;
wherein the first pivot lever joint is arranged below the pivot lever pivot axis such that the connecting member is subjected to a compression load.

17. A seat according to claim 16, wherein the base part comprises a first plate and a second plate.

18. The seat according to claim 17, wherein the first and second plates are aligned substantially parallel to each other.

19. The seat according to claim 18, wherein the transmission member and the gear wheel are arranged between the first and second base plates.

20. The seat according to claim 16, wherein the pivot lever, the connecting member and the transmission member together with joints form a mechanism for pivoting the pivot lever about the pivot axis on the third pivot lever joint by pivoting movement of the transmission member.

21. The seat according to claim 16, wherein the actuating member is partially fixed in the region of an outer side of the frame and the gear wheel of the actuating member and the base part together with the transmission member and the connecting member are fixed in the region of an inner side of the frame.

22. The seat according to claim 16, wherein the frame has an opening having a diameter which is greater than a diameter of the gear wheel such that the gear wheel passes therethrough.

23. The seat according to claim 16, wherein the transmission member is pivotally mounted on the base part about a transmission member pivot axis with a transmission member joint.

24. The seat according to claim 16, wherein the connecting member is pivotally mounted on the transmission member about a first connecting member pivot axis at a connecting member joint.

25. The seat according to claim 16, wherein the connecting member is subjected to a compression load in all positions of the connecting member.

26. The seat according to claim 16, further comprising a sliding carriage pivotally mounted to the pivot lever at a third pivot lever joint, wherein the first pivot lever joint between the pivot lever and the connecting member is arranged below the third pivot lever joint between the pivot lever and the sliding carriage in all positions of the first pivot lever joint.

27. The seat according to claim 16, wherein the teeth of the transmission member comprise a constant radial distance to the transmission member pivot axis.

28. A seat for a motor vehicle having a seat part and a back part pivotally attached to the seat part, the seat part comprising:
a sliding carriage;
a seat frame operably coupled to the sliding carriage by a plurality of pivot levers for relative movement to provide a height adjustment of the seat, wherein one of the plurality of pivot levers operates as a drive link for pivoting movement about a first pivot axis in a height adjustment device, the height adjustment device comprising:
a first assembly unit disposed on a first side of the seat frame and including a base part having first and second plates, a transmission member operably coupled to the base part for pivoting movement about a second pivot axis and a connecting member having a first end operably coupled to the transmission member for pivoting movement about a third pivot axis, wherein the transmission member has a plurality of teeth formed at a substantially constant radial distance to the second pivot axis; and
a second assembly unit disposed on a second side of the seat frame opposite the first side and including an actuating member having a gear wheel, wherein the second assembly unit is detachably fastened to the first assembly unit such that the gear wheel extends through a hole formed in the seat frame and meshes with the teeth on the transmission member for transmitting a force from the gear wheel to through the actuating member to the connecting member;
wherein a second end of the connecting member is operably coupled to the drive link for pivoting movement about a fourth pivot axis arranged below the first pivot axis such that the connecting member is subjected to a compression load in all positions of the connecting member.

29. The seat according to claim 28 wherein the second assembly unit further comprises a third plate rotatably supporting the actuating member, wherein the base part of the first assembly unit is detachably fastened to the third base plate such that the seat frame is disposed therebetween.

30. A method for manufacturing a seat comprising:
providing a base part, a transmission member having teeth, a connecting member;
pivotally mounting the transmission member and the connecting member on the base part to form a first assembly unit;
providing an actuating member having a gear wheel to form a second assembly unit;
providing a frame of a seat part for the seat;
pivotally mounting at least one pivot lever about a pivot axis for height adjustment of the seat frame by a pivoting movement of the at least one pivot lever; and
coupling the connecting member to the pivot lever at a first pivot lever joint so that a movement of the connecting member causes a pivoting movement of the pivot lever about the pivot axis
wherein the base part is provided in two parts as a first base plate and a second base plate.

31. The method according to claim 30, further comprising stamp forming the first and second base plates.

32. The method according to claim 30, further comprising arranging the transmission member and the gear wheel between the first and second base plate to form the first assembly unit.
